(19) United States
(12) Patent Application Publication
(10) Pub. No.: US 2026/0310192 A1
(43) Pub. Date: Oct. 8, 2026

(54) PERFORMANCE MODEL CONFIGURATION FOR ASSET PERFORMANCE MANAGEMENT

(71) Applicant: Honeywell International Inc., Charlotte, NC (US)

(72) Inventors: Vaibhav Kamath, Hariharapura (IN); Minal Dani, Bengaluru (IN); Sasi Alias Ezil Madhavan, Pondicherry (IN); Archisman Sarkar, Bengaluru (IN); Harikrishnan Ravindranathan, Ernakulam (IN)

(21) Appl. No.: 19/169,319

(22) Filed: Apr. 3, 2025

(51) Int. Cl. G05B 23/02; G05B 13/04

(52) U.S. Cl. CPC G05B 23/024; G05B 13/042; G05B 23/0235

(57) ABSTRACT

Devices, methods, and systems for model configuration for asset performance management are described herein. One method includes receiving, by a computing device, a plurality of data points associated with an operational performance of a mechanical device operating under a predefined performance parameter, generating, by a machine learning model of the computing device, a digitized performance curve for the mechanical device based on the plurality of data points and predefined performance parameter, extracting a plurality of baseline coefficients from the digitized performance curve, transferring the extracted plurality of baseline coefficients to an asset model associated with the mechanical device, validating the extracted plurality of baseline coefficients via image processing of the extracted plurality of baseline coefficients and supplied design data corresponding to the predefined performance parameter, and adjusting at least one operating condition associated with the mechanical device based on the validated extracted plurality of baseline coefficients.

### TECHNICAL FIELD

The present disclosure relates generally to devices, methods, and systems for performance model configuration for asset performance management.

### BACKGROUND

Performance curves can be utilized by a user in order to assess performance of a mechanical device against design conditions. A performance curve can be, for instance, a graphical representation that illustrates how a device performs across a range of conditions. For example, a compressor can include a performance curve illustrating a relationship between the compressor’s discharge pressure and its flow rate. Similarly, other mechanical devices can include performance curves as well that illustrate how the mechanical devices perform across a range of conditions.

Typically, performance curves are designed and published on paper by mechanical device manufacturers during an initial design phase. These performance curves are created for certain predefined cases and as such, are typically only applicable for the conditions under which they are designed.

### BRIEF DESCRIPTION OF THE DRAWINGS

FIG. 1 illustrates an example system for performance model configuration for asset performance management in accordance with one or more embodiments.

FIG. 2 illustrates a flow diagram of an example method for performance model configuration for asset performance management in accordance with one or more embodiments.

FIG. 3 illustrates an example performance model for configuration for asset performance management in accordance with one or more embodiments.

FIG. 4 illustrates a flow diagram of an example method for performance model configuration for asset performance management in accordance with one or more embodiments.

FIG. 5 illustrates an example computing device for performance model configuration for asset performance management in accordance with one or more embodiments.

### DETAILED DESCRIPTION

Devices, methods, and systems for model configuration for asset performance management are described herein. One method includes receiving, by a computing device, a plurality of data points associated with an operational performance of a mechanical device operating under a predefined performance parameter, generating, by a machine learning model of the computing device, a digitized performance curve for the mechanical device based on the plurality of data points and predefined performance parameter, extracting a plurality of baseline coefficients from the digitized performance curve, transferring the extracted plurality of baseline coefficients to an asset model associated with the mechanical device, validating the extracted plurality of baseline coefficients via image processing of the extracted plurality of baseline coefficients and supplied design data corresponding to the predefined performance parameter, and adjusting at least one operating condition associated with the mechanical device based on the validated extracted plurality of baseline coefficients.

Performance curves associated with assets (e.g., mechanical devices) are used by reliability engineers to assess a mechanical device’s current performance against design conditions. For devices such as compressors, pumps, and turbines, industry-wide approved standard performance curves are available and used across the industry for asset performance management. During the detailed design phase of these mechanical devices, based on the operating envelope identified, an engineer can design the particular mechanical device and generate performance curves for certain predefined cases for the mechanical device.

However, the performance maps supplied by the manufacturer are not broadly useful for performance monitoring as they are only applicable for conditions for which these curves are generated. As used herein, performance monitoring may refer to the inspection and analysis of operational data associated with a mechanical device. For precise performance monitoring, a user needs to manually digitize the supplied performance curves for all stages of the asset, as well as transform the curves to a reduced coordinate system that is independent of specific conditions. For example, manually digitizing the supplied performance curves can include using an open-source tool to scan and manually locate coordinates for each performance curve, of which a user needs to be aware of the number of points that will produce a proper digital representation of each curve. For each design case, there may be 4 or 5 speed curves for one key performance indicator (KPI), such as head vs. flow rate, for example. Similarly, a user needs to perform the same procedure to manually digitize supplied performance curves for three KPI’s (e.g., head, power, and efficiency), in which case the manufacturer may provide data for up to 6 design cases. As an example, for a 4-stage variable speed compressor including 5 speed curves, operation may be designed for a wide range of operating conditions (e.g., 4 cases), in which a user would need to manually extract data points from 240 performance curves. The extracted curve data would need to be manually transferred to separate offline tools for generating baseline coefficients and subsequently validating the generated baseline coefficients. In the event that the data is not validated successfully (e.g., there is an offset between the data and a model’s prediction), the user may need to repeat the process of digitizing the supplied performance curves from the beginning resulting in an overly tedious process with inconsistent results.

However, the digitization of performance curves allows the curves to be accurately used for performance monitoring for an asset’s entire operating range, which is necessary for precise performance monitoring. In general, current asset performance management solutions require baseline data to complete performance monitoring. However, these solutions involve manual effort to digitize performance as described previously, which is tedious, time-consuming and may be prone to error.

Performance models can be configured to predict operational performance of mechanical device assets for asset performance management utilizing performance curves. In some instances, machine learning models can be utilized to digitize performance curves for operational parameters associated with an asset to monitor the asset’s performance under set design conditions.

Performance model configuration for asset performance management according to the disclosure improves asset performance management by reducing the cognitive load on users through the automation of the process of digitizing supplied performance curves. By enabling auto-validation of digitized performance curves using image processing and vendor supplied images, the manual iterative digitizing process can be reduced. Further, automatic regression may be used to have KPI’s reported against the same flow rates for an asset.

The present disclosure also improves asset performance management by automatically generating baseline coefficients based on digitized data. Additionally, automatic validation using a KPI comparison may be used to regenerate the baseline coefficients. Overall, the present disclosure enhances the value of the asset performance management solution while reducing the time required to provide a meaningful solution as compared with previous approaches.

As an example, a supplied equipment data sheet may be read without any user assistance using a machine learning model. From the supplied equipment data sheet, the design case associated with each performance curve may be identified, along with the corresponding stage of the asset for which the supplied performance curve correlates. Different physical quantities and respective units of measurement associated with an asset’s performance curve can also be identified (e.g., head vs. flow rate, power vs. flow rate, associated design case, etc.).

An example method can begin with receiving, by a computing device, a plurality of data points comprising a predefined performance curve associated with an operational performance of a mechanical device operating under a predefined performance parameter. A plurality of coordinates may be extracted from the plurality of data points associated with the operational performance of the mechanical device. The method may further include identifying outliers within the plurality of data points and automatically smoothing the performance curve. Using the plurality of coordinates associated with the performance curve, a digitized curve may be generated for asset performance management.

The method may also include extracting a plurality of baseline coefficients from the digitized performance curve by a machine learning model and transferring the extracted plurality of baseline coefficients to an asset model. The asset model may validate the extracted plurality of baseline coefficients using supplied design data associated with the mechanical device. At least one operating condition associated with the mechanical device may be adjusted based on the validated extracted plurality of baseline coefficients.

As an example, a plurality of data points may be collected from one or more sensor devices (e.g., temperature sensor, pressure sensor, flow sensor, fluid level sensor) associated with an asset (e.g., mechanical device). The plurality of data points can include time series data sampled at certain time intervals and/or within a particular time period. The plurality of data points may be stored in a memory device or a database. The plurality of data points may be collected during a design phase of the mechanical device (e.g., during manufacturing of the mechanical device).

An asset can include mechanical devices associated with fluid power systems and turbomachinery control. For example, an asset may refer to a centrifugal compressor, a pump, or a turbine. An asset may refer to a single component within a mechanical device or the mechanical device as a whole.

The plurality of data points may be associated with a number of operating conditions (e.g., performance parameters) corresponding to the mechanical device. As used herein, the term operating condition refers to measurements and controls that define how a mechanical device operates. As an example, the number of operating conditions may include a type of gas handled by the mechanical device, a molecular weight of the gas handled by the mechanical device, a compressibility factor of the gas handled by the mechanical device, a specific heat ratio corresponding to the mechanical device, a suction temperature corresponding to the mechanical device, a discharge pressure corresponding to the mechanical device, an operating speed of the mechanical device, and/or a suction pressure of the mechanical device. Operating conditions may also include process variables associated with the mechanical device such as temperature, pressures, fluid level, flow rate, and/or stream composition.

In the following detailed description, reference is made to the accompanying drawings that form a part hereof. The drawings show by way of illustration how one or more embodiments of the disclosure may be practiced. These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

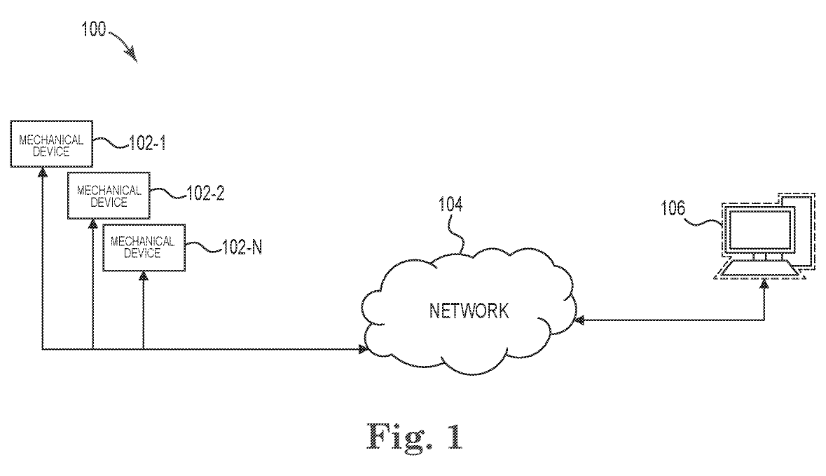

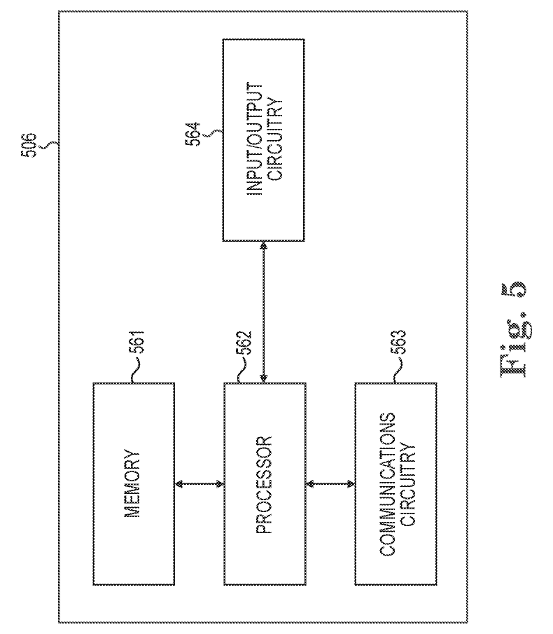

The figures herein follow a numbering convention in which the first digit or digits correspond to the drawing figure number and the remaining digits identify an element or component in the drawing. Similar elements or components between different figures may be identified by the use of similar digits. For example, 106 may reference element “06” in FIG. 1, and a similar element may be referenced as 506 in FIG. 5.

As used herein, “a”, “an”, or “a number of” something can refer to one or more such things, while “a plurality of” something can refer to more than one such things. For example, “a number of components” can refer to one or more components, while “a plurality of components” can refer to more than one component. Additionally, the designator “N”, as used herein, particularly with respect to reference numerals in the drawings, indicates that a number of the particular feature so designated can be included with a number of embodiments of the present disclosure.

FIG. 1 illustrates an example system 100 for performance model configuration for asset performance management in accordance with one or more embodiments. The system 100 can include a plurality of mechanical devices 102-1, 102-2, …, 102-N (which may collectively be referred to as mechanical devices 102), a network 104, and a computing device 106.

As used herein, a mechanical device can be a device that uses mechanical power to accomplish a particular task or function. The mechanical devices 102 can be, for instance, a compressor, pump, turbine, and/or other mechanical device.

As illustrated in FIG. 1, the system 100 can include a computing device 106 connected to a network 104. The computing device 106 may be a computing device that can be overseen by an administrator, data engineer, or other subject matter expert associated with asset performance management. The computing device 106 may receive data associated with any one of the mechanical devices 102 via network 104.

Network 104 can provide a network relationship through which mechanical devices 102 and computing device 106 can communicate. Examples of such a network relationship can include a distributed computing environment (e.g., a cloud computing environment), a wide area network (WAN) such as the Internet or a LoRaWAN, a local area network (LAN), a personal area network (PAN), a campus area network (CAN), or metropolitan area network (MAN), among other types of network relationships. For instance, network 104 can include a number of servers that receive information from, and transmit information to, mechanical devices 102 and computing device 106 via a wired or wireless network. The network 104 may also be comprised of a server (or servers) in a cloud computing infrastructure or environment.

As used herein, a “network” can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, a network can tie a number of computing devices, such as computing device 106, together to form a distributed control network (e.g., cloud).

The computing device 106 can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that device. Further, while a single computing device is illustrated, the term “computing device” shall also be taken to include any collection of computing devices that individually or jointly execute a set (or multiple sets) of instructions to perform any one or more of the methodologies discussed herein.

In alternative embodiments, the computing device 106 can be connected (e.g., networked) to other computing devices in a LAN, an intranet, an extranet, and/or the Internet. The computing device 106 can operate in the capacity of a server or a client device in client-server network environment, as a peer device in a peer-to-peer (or distributed) network environment, or as a server or a client device in a cloud computing infrastructure or environment.

Computing device 106 and/or network 104 can include a machine learning model for model configuration for asset performance management, as will be described herein. An asset performance model may also be utilized in the configuration of performance models for mechanical devices. As used herein, a machine learning model refers to a computing object trained on training data that can find patterns or make decisions based on an analysis of a previously unseen dataset. The machine learning model may be utilized to digitize performance curves associated with mechanical devices, automatically validate the digitized performance curve using a vendor supplied image using image processing techniques, and automatically generate baseline coefficients corresponding to the performance of the mechanical device under various operating conditions among other functions, as is further described herein.

In general, asset performance management can utilize real-time data corresponding to a performance of mechanical device 102-1 under certain operating parameters to determine whether a potential fault, failure, or other problem with mechanical device 102-1 is occurring based on a comparison of the expected performance of mechanical device 102-1 under the operating parameters and the current performance of mechanical device 102-1 under the operating parameters. By analyzing a performance curve of mechanical device 102-1 under current operating conditions, the overall performance for mechanical device 102-1 may be evaluated, and ultimately adjusted, as part of managing the performance of mechanical device 102-1 as an asset. As an example, mechanical devices 102-2, …, 102-N may be assets operating under similar operating conditions or have similar characteristics to mechanical device 102-1. In this example, by evaluating the performance of mechanical device 102-1, the operational performance of mechanical devices 102-2, …, 102-N may be predicted and managed as well.

In some embodiments, network 104 is configured to receive, generate, and cause transmission of data to computing device 106. Such data can include, for instance, a plurality of data points associated with a performance of one or more mechanical devices. In some embodiments, the network 104 is configured to receive data from one or more mechanical devices 102-1, …, 102-N. In some embodiments, the received data refers to data obtained by recording readings of one or more sensor devices configured to monitor one or more mechanical devices 102 (e.g., a boiler, compressor, system, and/or other type of equipment or device). Examples of sensor devices whose readings are used to generate such data can include pressure (e.g., water pressure, air pressure, etc.) sensor devices, temperature sensor devices, motion sensor devices, environmental sensor devices, fan angular motion sensor devices, cameras, audio recorders, and/or the like.

As one example, a mechanical device such as a compressor may be associated with sensor devices monitoring data of the compressor. In this regard, example sensor devices that monitor data of the compressor may include a discharge temperature sensor, a discharge pressure sensor, a flow sensor, a suction drum level sensor, a suction temperature sensor, a suction pressure sensor, a control valve output sensor, a motor current sensor, a speed sensor, a motor temperature sensor, and/or the like. Such sensors can sense and record data associated with the compressor, such as discharge temperature, discharge pressure, a flow rate, etc. This data can be transmitted from the sensor associated with the compressor and can be received by the network 104 and/or computing device 106 for use in general asset performance management.

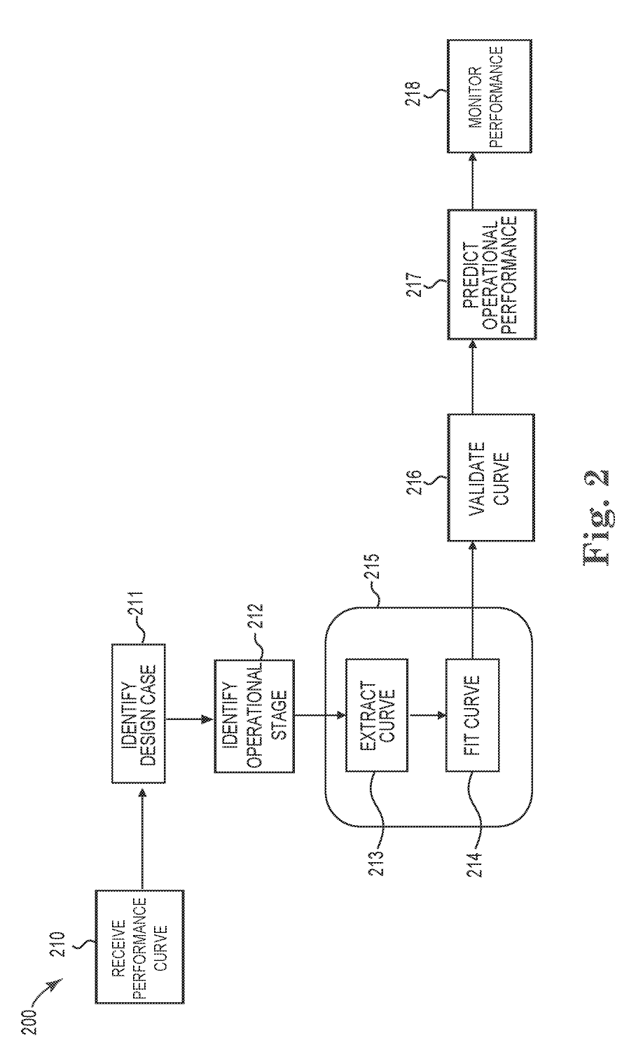

FIG. 2 illustrates a flow diagram of an example method 200 for performance model configuration for asset performance management in accordance with one or more embodiments. The method 200 illustrated in FIG. 2 may be performed by a machine learning model stored in network 104 and/or computing device 106, as previously described in connection with FIG. 1.

At operation 210, network 104 or computing device 106 may receive a plurality of performance curves associated with an operational performance of a mechanical device asset, such as mechanical device 102-1 described in connection with FIG. 1. The performance curves may include a plurality of data points associated with performance data of a mechanical device operating under certain operating conditions, such as pre-generated performance curves supplied by the manufacturer for each mechanical device. The performance curves can be imported (e.g., received or otherwise accessed) from a variety of sources. For example, the performance curves may be received (e.g., via network 104) from the original equipment manufacturer of the mechanical device generated during the design phase of the mechanical device. The performance curves may be configured for digitization to aid in the performance management of each mechanical device, as is further described herein.

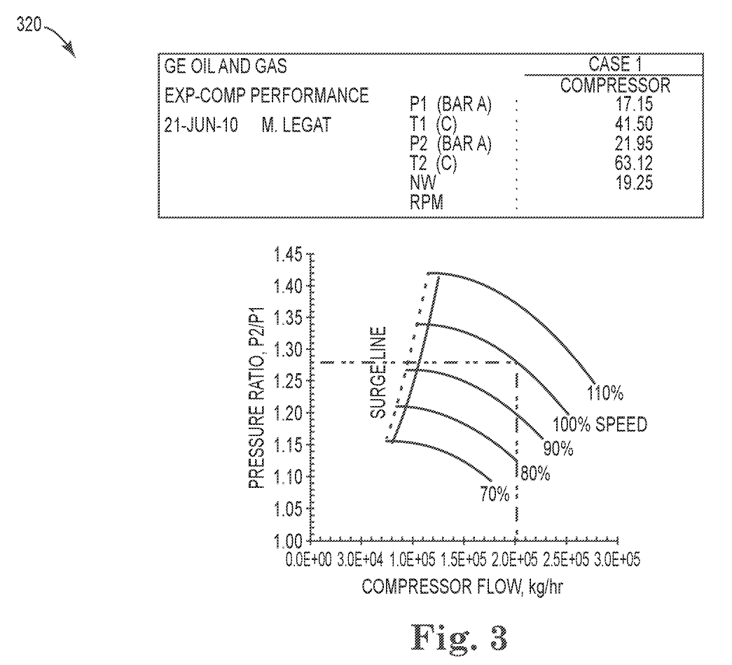

The performance curves may include data (e.g., a plurality of data points) associated with one or more mechanical devices 102. For example, the plurality of data points may make up a performance curve associated with each mechanical device 102, as will be described in more detail in connection with FIG. 3. The performance data may include multiple operational conditions. For example, the plurality of data points making up the performance curve may include one or more than one operational condition under which the corresponding mechanical device operates. In the context of the pre-generated performance curves supplied by the manufacturer, the operational conditions may be associated with a particular operating state or preferred performance of the mechanical device. As used herein, an operational condition is a condition in which the associated mechanical device is operating under, such as a setting or configuration for example. The operational condition(s) may be predefined by a user in some examples. Alternatively, the operational condition(s) may be unknown at the start of the configuration process and may be derived as part of the configuration process.

At operation 211, the method 200 includes identifying a design case associated with each performance curve. Identifying the design case may include deriving the settings, parameters, and/or operational conditions under which the mechanical device is performing. For example, identifying the design case may include identifying the operational conditions under which the performance curve was generated. As an example, the design case may define the operating parameters under which the mechanical device was designed to operate under. Accordingly, each performance curve received may define an operational performance of the mechanical device operating under the identified design case. A design case associated with each performance curve among the plurality of performance curves of a mechanical device may be identified by a machine learning model of the computing device.

At operation 212, an operational stage may be identified for a mechanical device based on each performance curve. An operational stage may refer to a particular stage under which the mechanical device is operating during the generation of the performance curve. As an example, a compressor-type mechanical device may include several stages of operation in order to complete mechanical work. Using a machine learning model, the operational stage of the compressor may be identified based on the corresponding performance curve.

Operation 215 can comprise operations 213 and 214 and can be performed by a machine learning model, such as the machine learning model used in operations 211 and 212. The machine learning model may be included within network 104 and/or computing device 106 as described in connection with FIG. 1. Performance model configuration at operation 215 may be performed by the same machine learning model such that a performance model may be configured accurately and efficiently. Performance model configuration at operation 215 may be performed automatically upon receiving performance data from a customer site, as is further described herein.

At operation 215, the method 200 includes generating, by the machine learning model, a digitized performance curve for the mechanical device based on the plurality of data points and a predefined performance parameter. The predefined performance parameter may include the identified design case, the identified operational stage, or both. For example, at operation 213, the method 200 includes extracting curves from the plurality of data points associated with a performance curve of a mechanical device. Curve extraction refers to the process of identifying and extracting curves or continuous shape features from data. As mentioned previously, the imported performance curve at operation 210 may include a plurality of data points associated with the performance of a mechanical device. Oftentimes, data includes outliers and/or anomalies that may skew the data. By applying a curve extraction, the data may be accurately represented in order to make accurate inferences into the performance of the associated mechanical device. Curve extraction can be applicable to any device type (e.g., a compressor, pump, turbine, and/or other mechanical device).

Curve extraction can include various steps. For example, traditional computer vision (CV) algorithms and noise cancellation via random sample consensus (RANSAC) regression may be applied to the received performance curve to extract defined curves from the data. CV algorithms refer to image-processing techniques that utilize mathematical operations to transform a dataset. RANSAC regression refers to an iterative process that utilizes random selections of data subsets, fitting a model using the random selections, and determining the best model based on consensus. RANSAC regression may aid in the reduction of noise (e.g., outliers) within a received dataset. The process of curve extraction may be performed automatically upon receiving a plurality of data associated with the performance of a mechanical device.

At operation 214, the method 200 may include fitting the extracted curve. Curve fitting refers to the process of fitting mathematical functions to experimental data. Curve fitting may be applied to performance data to derive a defined performance curve for various mechanical devices. Various known methods of curve fitting may be applied such as Python model integration, for example.

The method 200 may include extracting, by the machine learning model, a plurality of baseline coefficients from the digitized performance curve. The plurality of baseline coefficients may be used to define the digitized performance curve. The configured performance model may then be transferred to an asset model. The asset model may be located within network 104 and/or computing device 106 as described in connection with FIG. 1. The asset model may be used to further configure the digitized performance curve for use based on the associated mechanical device. For example, the asset model may provide further configuration such that the digitized performance curve may be applied to the operation of the mechanical device.

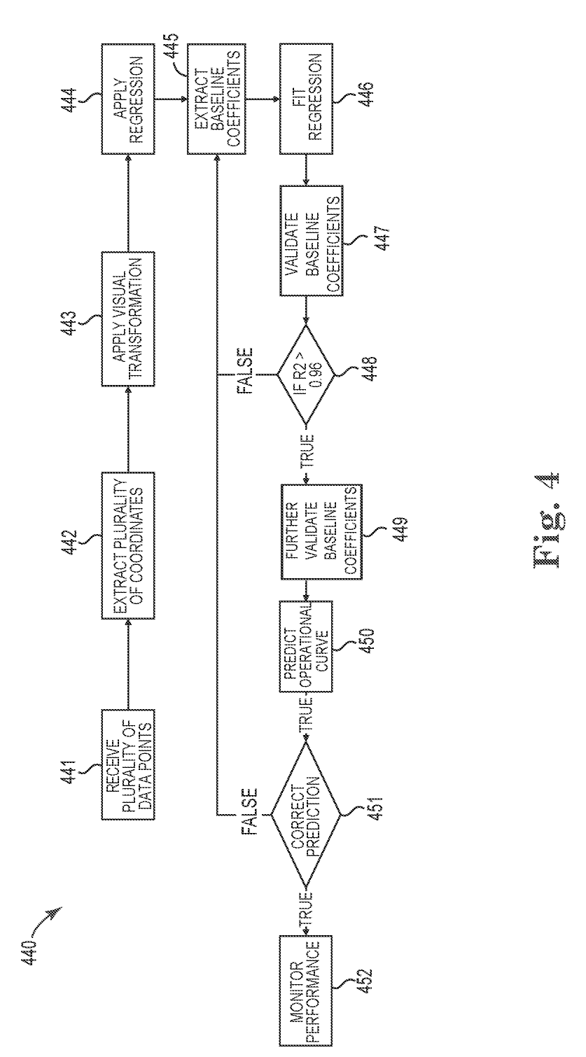

At operation 216, the digitized performance curve may be validated. Validating the performance curve can be applicable to any device type (e.g., a compressor, pump, turbine, and/or other mechanical device). Validating the performance curve may include comparing the digitized performance curve from operation 215 to expected performance curve models using image processing. The expected curve models may be supplied design data by a manufacturer of the mechanical device or may be previously digitized performance curves. Further, the expected curve models may illustrate the expected performance of a mechanical device under predefined operating conditions or performance parameters. Validating the model may be used to make inferences about the overall performance of the mechanical device based on an expected performance of the mechanical device under the same set conditions. Validating the extracted plurality of baseline coefficients from the digitized performance curve (e.g., for mechanical devices such as pumps, turbines, etc.) via image processing of the extracted plurality of baseline coefficients and supplied design data corresponding to the identified design case and the identified operational stage of the mechanical device may be performed by the asset model. Although baseline coefficients can be extracted for mechanical devices such as pumps, turbines, etc., in some examples, baseline coefficients have to be generated for certain mechanical devices such as centrifugal compressors, as is further described in connection with FIG. 4.

At operation 217, an operational performance curve for the mechanical device may be predicted based on the extracted plurality of baseline coefficients from the digitized performance curve via the asset model. The operational performance for the mechanical device may be predicted under set operational conditions for future use. Once the performance curves have been successfully digitized, expected performance of the associated mechanical device may be predicted to aid in the overall management of the mechanical device asset.

At operation 218, the performance of the mechanical device may be monitored using the predicted operational performance curve. After the digitized performance curve has been validated, the performance curve may be used for asset performance management. The performance curve may be stored at computing device 106, for example, for future use in managing the performance of a mechanical device. Asset performance management may include utilizing the performance curve to adjust operating conditions of the mechanical device to improve performance and/or efficiency. A performance curve is further illustrated and described in connection with FIG. 3.

FIG. 3 illustrates an example of data 320 included in a performance model for configuration for asset performance management in accordance with one or more embodiments. For instance, FIG. 3 illustrates data associated with the performance of compressor.

FIG. 3 is an example of performance data associated with a mechanical device that may be received by network 104 and/or computing device 106 for configuration. The performance data can include a plurality of data points associated with an operational performance of a mechanical device operating under a predefined performance parameter. The example performance data of FIG. 3 may be illustrative of the data to be configured at operation 215, as described in connection with FIG. 2.

As illustrated in FIG. 3, performance data associated with a compressor is arranged into a graphical curve representation including a plurality of data points that represent a relationship between a compressor flow rate (e.g., an amount of air flowing through a compressor) and a pressure ratio (e.g., of the outlet pressure to inlet pressure) at varying compressor speeds. In this particular example, the compressor corresponds to customer “GE Oil and Gas” and illustrates an experimental compressor performance (e.g., “EXP-COMP PERFORMANCE). The details illustrated in FIG. 3 are purely exemplary to illustrate a particular embodiment of the present disclosure. Information included in performance data received may include more or fewer details than those illustrated in the example of FIG. 3.

As mentioned above, the performance data for configuration may further include physical quantities and associated units of measurement associated with the particular mechanical device. For example, as illustrated in FIG. 3, the performance model includes a plurality of data points that represent the relationship between compressor flow rate (on the horizontal X-axis in kilograms per hour (kg/hr)) and pressure ratio (on the vertical Y-axis) at varying compressor speeds (e.g., 70%, 80%, 90%, 100%, 110%). In other words, the example of FIG. 3 illustrates the compressor speed as a function of the pressure ratio and compressor flow. In the example of FIG. 3, various pressure measurements are included, represented by “P1” and “P2” in units of “Bar A” associated with atmospheric pressure. Temperature measurements are represented by “T1” and “T2” in units of degrees Celsius (e.g., C). The nominal weight is included with the designation “NW”, as well as the speed (value not illustrated) in revolutions per minute (e.g. RPM). Lastly, a surge line is included to illustrate the associated pressure ratio and compressor flow at which the compressor reached a speed of 100%.

Additional details in a performance model for configuration may include a design case associated with the mechanical device. The design case may refer to a specific set of operating conditions or performance parameters associated with the performance curve. In the example of FIG. 3, the design case corresponds to “Case 1”. Although not illustrated in the example of FIG. 3, the performance model for configuration may include an operational stage associated with the mechanical device.

While the data illustrated in FIG. 3 includes a plurality of data points associated with an operational performance of a compressor, embodiments are not so limited. For example, the data including the plurality of data points can be associated with an operational performance of the compressor operating at different input temperatures and pressures (e.g., different predefined performance parameters). Additionally and/or alternatively, the data including the plurality of data points can be associated with an operational performance of a different mechanical device operating at particular predefined performance parameters. Such different mechanical devices can include a pump, turbine, or any other type of mechanical device having performance curves associated therewith.

The plurality of data points in FIG. 3 is illustrative of the performance data to be configured for operational performance of a mechanical device. As can be seen in FIG. 3, manually digitizing the data illustrated in FIG. 3 can be a tedious, time-consuming task which may be prone to error. Therefore, from this data, a performance curve may be extracted via a machine learning model, as briefly described in connection with FIG. 2 at operation 215 and as is further described in more detail in connection with FIG. 4.

FIG. 4 illustrates a flow diagram of an example method 440 for performance model configuration for asset performance management in accordance with one or more embodiments. The method 440 may comprise the steps of operation 215 of FIG. 2, for example. Additionally, the method 440 may be performed by a machine learning model included within computing device 106 and/or network 104, previously described in connection with FIG. 1.

At operation 441, the method 440 includes receiving a plurality of data points associated with an operational performance of a mechanical device operating under a predefined performance parameter. The mechanical device may be any type of mechanical device associated with performing work. The plurality of data points may correspond to performance data associated with the mechanical device and may be represented in a similar manner to the example of FIG. 3, but embodiments are not so limited.

At operation 442, a plurality of coordinates may be extracted from the received plurality of data points. For example, a plurality of coordinates may be extracted from the performance data such that a curve may be derived from the plurality of coordinates. The extracted plurality of coordinates may be representative of a performance curve associated with the mechanical device under set operating conditions. Extracting the plurality of coordinates may be included within a process of digitizing a performance curve from the received data.

At operation 443, the method 440 includes applying a visual transformation to the extracted plurality of coordinates and/or the plurality of data points as part of digitizing the performance curve. The visual transformation applied may include using large language models (e.g., LLM) and computer vision techniques to understand the data. Applying a visual transformation may be associated with extracting the performance curve, as previously described at operation 213 of FIG. 2.

At operation 444, the method 440 includes applying a regression to the visually transformed plurality of data points. For example, traditional computer vision (CV) algorithms and noise cancellation via random sample consensus (RANSAC) regression may be applied to the received data to extract performance curves from the data. RANSAC regression may aid in the reduction of noise (e.g., outliers) within the received dataset to smooth a curve. After applying an appropriate regression to the data, a digitized performance curve is generated.

At operation 445, the method 440 includes extracting baseline coefficients from the digitized performance curve. Extracting baseline coefficients can be performed for mechanical devices such as pumps, turbines, and/or other mechanical devices. However, extracting baseline coefficients is not possible for all mechanical devices, such as centrifugal compressors. For mechanical devices such as centrifugal compressors, generating baseline coefficients is included within the performance model configuration process. For asset types of other mechanical devices, generating baseline coefficients may not be possible as part of the process of configuring a performance model.

The generated baseline coefficients may further define a performance curve for the mechanical device associated with the received data. Additionally, there may be more than one performance curve derived from a single dataset. As such, baseline coefficients may be derived from each performance curve.

At operation 446, a regression analysis may be applied. The digitized performance curve and associated baseline coefficients may be fit for accuracy by applying a regression analysis (e.g., R2). R2 in regression is a statistical measure of how well the model fits the data. For example, the digitized performance curve may be analyzed according to supplied design data for the mechanical device under a predefined performance parameter and a determination may be made as to how accurate the digitized performance curve aligns with the supplied design data.

At operation 447, a validation of the extracted plurality of baseline coefficients may be performed. The validation may include using image processing to determine whether the generated digitized performance curve aligns with a vendor supplied image. At operation 448, a regression analysis is performed on the validated performance curve. If the value of R2 is greater than 0.96, then the method 440 proceeds to operation 449 to perform a second validation of the performance curve. When the value of R2 is greater than 0.96, then the performance curve explains 96% of the variance included within the received data. This is considered a very high level of model fit. At operation 448, if the regression analysis produces an R2 value that is less than 0.96, then the method 440 returns to operation 445 in order to tune the baseline coefficients.

While the R2 values are described above as being 0.96, embodiments are not so limited. For example, different R2 values may be utilized for the regression analysis of the digitized performance curve.

At operation 449, a further validation of the extracted baseline coefficients corresponding to the digitized performance curve is performed. The validation performed at operation 449 may be the same type of validation performed at operation 447, or a different validation method may be employed.

At operation 450, a prediction of an operational curve for the mechanical device is performed. Using the validated baseline coefficients and digitized performance curve, an actual operating curve for the mechanical device may be predicted. At operation 451, a determination is made as to whether the predicted operational curve is a correct prediction based on the operating conditions under which the mechanical device is operating. If the predicted operational curve is a correct prediction, then the method 440 proceeds to operation 452. If the predicted operational curve is an incorrect prediction, then the method 440 returns to operation 445 to re-tune the baseline coefficients associated with the performance curve of the mechanical device.

At operation 452, the mechanical device asset may be deployed and performance of the mechanical device may be monitored. The digitized performance curve may be used to compare an expected performance of the mechanical device to the predicted operational curve illustrative of the actual performance of the mechanical device under the same operating conditions. Determinations may be made as to the overall efficiency and performance of the mechanical device and adjustments may be made to operational conditions or performance parameters as a result.

In one example, the method 440 can be performed for performance model configuration for asset performance management for a pump. For example, at 440 the machine learning model can receive a plurality of data points associated with an operational performance of the pump operating under a predefined performance parameter. The plurality of data points can be a performance curve for a flow rate vs head (e.g., a height at which a pump can raise a fluid).

At 442, a plurality of coordinates can be extracted from the plurality of data points for the pump. The extracted plurality of coordinates for the pump may be representative of the performance curve associated with the pump under set operating conditions, such as an amount of power supplied to the pump. Extracting the plurality of coordinates may be included within a process of digitizing a performance curve from the received data.

The machine learning model can apply a visual transformation to the extracted plurality of coordinates in order to digitize the performance curve. The visual transformation can include utilizing an LLM and computer vision techniques.

At operation 444, the method 440 includes applying a regression to the visually transformed plurality of data points for the pump. For example, traditional computer vision (CV) algorithms and noise cancellation via random sample consensus (RANSAC) regression may be applied to the received data and a digitized performance curve can thus be generated for the pump. Additionally, at 445, baseline coefficients can be extracted from the digitized performance curve for the pump.

The machine learning model can further apply a regression analysis at 446 in order to statistically measure how well the model fits the data for the pump. For example, the digitized performance curve for the pump can be analyzed according to supplied design data for the pump under a predefined performance parameter and a determination may be made as to how accurate the digitized performance curve aligns with the supplied design data. For instance, if the R2 value for the curve is greater than 0.96, then the method 440 proceeds to operation 449 to perform a second validation of the performance curve. At operation 448, if the regression analysis produces an R2 value that is less than 0.96, then the method 440 returns to operation 445 to re-tune the baseline coefficients.

At operation 450, a prediction of an operational curve for the pump is performed. Using the validated baseline coefficients and digitized performance curve, an actual operating curve for the pump may be predicted. At operation 451, a determination is made as to whether the predicted operational curve is a correct prediction based on the operating conditions under which the mechanical device is operating. In response to the predicted operational curve being the correct prediction, then the method 440 proceeds to operation 452. At operation 452, the pump may be deployed and performance of the pump may be monitored according to asset performance management techniques. The digitized performance curve may be used to compare an expected performance of the pump to the predicted operational curve illustrative of the actual performance of the pump under the same operating conditions. Determinations may be made as to the overall efficiency and performance of the pump and adjustments may be made to operational conditions or performance parameters as a result.

Accordingly, performance model configuration for asset performance management can allow for the automatic digitization of performance curves for mechanical devices, such as those supplied by a manufacturer. The digitized performance curves can significantly reduce the efforts in manually digitizing supplied performance curves, allowing for more robust asset performance management for mechanical devices, as compared with previous approaches.

FIG. 5 illustrates an example computing device for performance model configuration for asset performance management in accordance with one or more embodiments. Computing device 506 can be, for example, computing device 106 previously described in connection with FIG. 1. As illustrated in FIG. 5, the computing device 506 can include a memory 561 and a processor 562 for performance model configuration for asset performance management in accordance with the present disclosure.

The memory 561 can be any type of storage medium that can be accessed by the processor 562 to perform various examples of the present disclosure. For example, the memory 561 can be a non-transitory computer readable medium having computer readable instructions (e.g., executable instructions/computer program instructions) stored thereon that are executable by the processor 562 for performance model configuration for asset performance management in accordance with the present disclosure.

The memory 561 can be volatile or nonvolatile memory. The memory 561 can also be removable (e.g., portable) memory, or non-removable (e.g., internal) memory. For example, the memory 561 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 561 is illustrated as being located within computing device 506, embodiments of the present disclosure are not so limited. For example, memory 561 can also be located internal to another computing resource (e.g., enabling computer readable instructions to be downloaded over the Internet or another wired or wireless connection).

For example, the memory 561 can comprise instructions that, when executed, cause the processor 562 to receive a plurality of performance curves associated with an operational performance of a mechanical device, identify, by a machine learning model of the computing device, a design case associated with each performance curve among the plurality of performance curves of the mechanical device, identify, by the machine learning model, an operational stage of the mechanical device based on each performance curve, generate, by the machine learning model, a digitized performance curve for the mechanical device based on the identified design case and the identified operational stage of the mechanical device, extract, by the machine learning model, a plurality of baseline coefficients from the digitized performance curve, transfer the extracted plurality of baseline coefficients to an asset model associated with the mechanical device, validate, by the asset model, the extracted plurality of baseline coefficients via image processing of the extracted plurality of baseline coefficients and supplied design data corresponding to the identified design case and the identified operational stage of the mechanical device, predict, by the asset model, an operational performance curve for the mechanical device based on the extracted plurality of baseline coefficients, and monitor a performance of the mechanical device using the predicted operational performance curve.

The instructions may further include storing the operational performance curve in the memory resource for future asset performance management. The instructions may further include determine, by the asset model, whether the predicted operational performance curve is an accurate prediction based on a supplied performance curve of the mechanical device operating under the identified design case and the identified operational stage. When it is determined that the predicted operational performance curve is not an accurate prediction, the baseline coefficients are re-generated. Further, when it is determined that the predicted operational performance curve is an accurate prediction, the mechanical device may be deployed for use at the customer site.

The processor 562 may be a central processing unit (CPU), a semiconductor-based microprocessor, and/or other hardware devices suitable for retrieval and execution of machine-readable instructions stored in the memory 561. The processor 562 may be in communication with the memory 561 via a bus for passing information among components of the computing device 506. The processor 562 may include one or more processing devices configured to perform independently in some embodiments. Alternatively, the processor 562 may include one or more processing devices configured to perform concurrently to execute one or more instructions stored in memory 561.

The computing device 506 can include input/output circuitry 564 in some embodiments. The input/output circuitry 564 may be in communication with processor 562 to provide an output (e.g., to a user) or receive an indication of an input (e.g., by a user). The input/output circuitry 564 may include a user interface, which may be a display, a web user interface, a mobile application, or a query initiating computing device, in some examples. The input/output circuitry 564 may also include a keyboard, a mouse, a joystick, a touch screen, a microphone, a speaker, or other input/output mechanisms.

The computing device 506 may include communications circuitry 563, in some embodiments of the present disclosure, as illustrated in FIG. 5. The communications circuitry 563 may include circuitry embodied in hardware and/or software that is configured to receive and/or transmit data to/from a network, such as network 104 described in connection with FIG. 1. Communications circuitry 563 may be configured to transmit data to/from other devices, circuitry, or modules in communication with the computing device 506. The communications circuitry 563 may include one or more network interface cards, buses, modems, switches, and/or routers for enabling communications via a network.

The computing device 506 can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that device. Further, while a single computing device is illustrated, the term “computing device” shall also be taken to include any collection of devices that individually or jointly execute a set (or multiple sets) of instructions to perform any one or more of the methodologies discussed herein.

In alternative embodiments, the computing device 506 can be connected (e.g., networked) to other computing devices in a LAN, an intranet, an extranet, and/or the Internet. The computing device can operate in the capacity of a server or a client device in client-server network environment, as a peer device in a peer-to-peer (or distributed) network environment, or as a server or a client device in a cloud computing infrastructure or environment.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving, by a computing device, a plurality of data points associated with an operational performance of a mechanical device operating under a predefined performance parameter;
generating, by a machine learning model of the computing device, a digitized performance curve for the mechanical device based on the plurality of data points and the predefined performance parameter;
extracting, by the machine learning model, a plurality of baseline coefficients from the digitized performance curve;
transferring, by the computing device, the extracted plurality of baseline coefficients to an asset model associated with the mechanical device;
validating, by the asset model, the extracted plurality of baseline coefficients via image processing of the extracted plurality of baseline coefficients and supplied design data corresponding to the predefined performance parameter; and
adjusting, by the computing device, at least one operating condition associated with the mechanical device based on the validated extracted plurality of baseline coefficients.

2. The method of claim 1, wherein the machine learning model of the computing device generates the digitized performance curve by:
applying a visual transformation to the plurality of data points;
applying a regression to the visually transformed plurality of data points using a random sample consensus; and
fitting the regression to generate the digitized performance curve.

3. The method of claim 1, wherein the method further includes managing, by the computing device, a performance of the mechanical device based on the validated extracted plurality of baseline coefficients.

4. The method of claim 1, wherein the method includes receiving the plurality of data points associated with the operational performance of the mechanical device from one or more sensor devices associated with the mechanical device.

5. The method of claim 1, wherein the mechanical device is a centrifugal compressor.

6. The method of claim 1, wherein the method further includes:
identifying, by the machine learning model, a design case corresponding to the plurality of data points associated with the operational performance of the mechanical device;
identifying, by the machine learning model, a plurality of conditions corresponding to the plurality of data points associated with the operational performance of the mechanical device; and
monitoring, by the computing device, a performance of the mechanical device based on the identified design case and the plurality of conditions.

7. The method of claim 1, wherein the method is performed automatically upon receiving the plurality of data points associated with the operational performance of the mechanical device.

8. The method of claim 1, wherein the method includes:
tuning, by the machine learning model, the extracted plurality of baseline coefficients based on a supplied operating curve; and
adjusting, by the computing device, performance of the mechanical device using the tuned plurality of baseline coefficients.

9. A non-transitory computer readable medium storing instructions executable by a processing resource that when executed, cause the processing resource to:
extract, by a machine learning model, a plurality of coordinates from a plurality of data points comprising a performance curve associated with an operational performance of a mechanical device operating under a predefined performance parameter;
generate, by the machine learning model, a digitized performance curve for the mechanical device from the plurality of coordinates;
extract, by the machine learning model, a plurality of baseline coefficients from the digitized performance curve;
transfer the extracted plurality of baseline coefficients to an asset model associated with the mechanical device;
validate, by the asset model, the extracted plurality of baseline coefficients via image processing of the extracted plurality of baseline coefficients and supplied design data corresponding to the predefined performance parameter;
predict, by the asset model, an operational performance curve for the mechanical device based on the extracted plurality of baseline coefficients and predefined performance parameter;
monitor a performance of the mechanical device using the predicted operational performance curve; and
adjust at least one operating condition associated with the mechanical device based on the predicted operational performance curve.

10. The non-transitory computer readable medium of claim 9, further comprising instructions to monitor the performance of the mechanical device using the predicted operational performance curve including:
determine a current performance of the mechanical device;
compare the determined current performance of the mechanical device to the predicted operational performance curve of the mechanical device; and
adjust the at least one operating condition associated with the mechanical device based on the comparison.

11. The non-transitory computer readable medium of claim 9, further comprising instructions to generate the plurality of baseline coefficients in response to the mechanical device being a centrifugal compressor device.

12. The non-transitory computer readable medium of claim 9, wherein validating the extracted plurality of baseline coefficients includes performing a regression analysis on the extracted plurality of baseline coefficients to determine whether the extracted plurality of baseline coefficients are an accurate model of the performance of the mechanical device.

13. The non-transitory computer readable medium of claim 12, wherein, when it is determined that the extracted plurality of baseline coefficients are not an accurate model of the performance of the mechanical device based on the regression analysis, the extracted plurality of baseline coefficients are re-tuned.

14. The non-transitory computer readable medium of claim 12, wherein, when it is determined that the extracted plurality of baseline coefficients are an accurate model of the performance of the mechanical device based on the regression analysis, a further validation of the extracted plurality of baseline coefficients is performed.

15. The non-transitory computer readable medium of claim 9, wherein validating the extracted plurality of baseline coefficients is performed automatically.

16. A computing device for asset performance management, comprising:
a processing resource; and
a memory resource storing non-transitory machine-readable instructions that when executed, cause the processing resource to:
receive a plurality of performance curves associated with an operational performance of a mechanical device;
identify, by a machine learning model of the computing device, a design case associated with each performance curve among the plurality of performance curves of the mechanical device;
identify, by the machine learning model, an operational stage of the mechanical device based on each performance curve;
generate, by the machine learning model, a digitized performance curve for the mechanical device based on the identified design case and the identified operational stage of the mechanical device;
extract, by the machine learning model, a plurality of baseline coefficients from the digitized performance curve;
transfer the extracted plurality of baseline coefficients to an asset model associated with the mechanical device;
validate, by the asset model, the extracted plurality of baseline coefficients via image processing of the extracted plurality of baseline coefficients and supplied design data corresponding to the identified design case and the identified operational stage of the mechanical device;
predict, by the asset model, an operational performance curve for the mechanical device based on the extracted plurality of baseline coefficients; and
monitor a performance of the mechanical device using the predicted operational performance curve.

17. The computing device of claim 16, wherein the instructions further include storing the operational performance curve in the memory resource for future asset performance management.

18. The computing device of claim 16, wherein the instructions further include determine, by the asset model, whether the predicted operational performance curve is an accurate prediction based on a supplied performance curve of the mechanical device operating under the identified design case and the identified operational stage.

19. The computing device of claim 18, wherein, when it is determined that the predicted operational performance curve is not an accurate prediction, the baseline coefficients are re-generated.

20. The computing device of claim 18, wherein, when it is determined that the predicted operational performance curve is an accurate prediction, the mechanical device may be deployed.
